(19) United States
(12) Patent Application Publication
(10) Pub. No.: US 2012/0207069 A1
(43) Pub. Date: Aug. 16, 2012

(54) DISCONTINUOUS RECEPTION (DRX) OPTIMIZATIONS

(75) Inventors: HAO XU, SAN DIEGO, CA (US); MADHAVAN SRINIVASAN VAJAPEYAM, SAN DIEGO, CA (US); FATIH ULUPINAR, SAN DIEGO, CA (US); YONGBIN WEI, SAN DIEGO, CA (US)

(73) Assignee: QUALCOMM INCORPORATED, San Diego, CA (US)

(21) Appl. No.: 13/370,245

(22) Filed: Feb. 9, 2012

Related U.S. Application Data
(60) Provisional application No. 61/441,544, filed on Feb. 10, 2011.

(51) Int. Cl. H04W 52/02

(52) U.S. Cl. 370/311

(57) ABSTRACT

Certain aspects of the present disclosure provide methods and apparatus for optimizing discontinuous reception (DRX) modes, for example, based on monitored traffic statistics.

### CROSS-REFERENCE TO RELATED APPLICATION(S)

This application claims benefit of U.S. Provisional Patent Application Ser. No. 61/441,544 (Atty. Dkt. No. 110931P1), filed Feb. 10, 2011, herein incorporated by reference.

### BACKGROUND

1. Field

Certain aspects of the present disclosure generally relate to wireless communications and, more particularly, to mobility enhancements for Long Term Evolution (LTE) discontinuous reception (DRX) operations.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Mobile Telecommunications System (UMTS), a third generation (3G) mobile phone technology supported by the 3rd Generation Partnership Project (3GPP). UMTS includes a definition for a Radio Access Network (RAN), referred to as UMTS Terrestrial Radio Access Network (UTRAN). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. For example, third-generation UMTS based on W-CDMA has been deployed all over the world. To ensure that this system remains competitive in the future, 3GPP began a project to define the long-term evolution of UMTS cellular technology. The specifications related to this effort is formally known as Evolved UMTS Terrestrial Radio Access (E-UTRA) and Evolved UMTS Terrestrial Radio Access Network (E-UTRAN), but are more commonly referred to by the project name Long Term Evolution, or LTE for short.

E-UTRAN is a RAN standard meant to be a replacement of the UMTS, High-Speed Downlink Packet Access (HSDPA) and High-Speed Uplink Packet Access (HSUPA) technologies specified in 3GPP release 5 and beyond. Unlike HSPA, LTE's E-UTRA is an entirely new air interface system, unrelated to and incompatible with W-CDMA. It provides higher data rates and lower latency and is optimized for packet data. E-UTRA uses orthogonal frequency-division multiple access (OFDMA) for the downlink and single-carrier frequency-division multiple access (SC-FDMA) on the uplink. In E-UTRAN, the protocol stack functions consist of the Media Access Control (MAC), Radio Link Control (RLC), Packet Data Convergence Protocol (PDCP), and Radio Resource Control (RRC) layers.

### SUMMARY

Certain aspects of the present disclosure generally relate to ways to enhance mobility signaling for a user equipment (UE) operating in a discontinuous reception (DRX) mode.

Certain aspects provide a method for wireless communication by a user equipment (UE). The method generally includes analyzing statistics related to packet traffic at the UE and providing a recommendation to a base station for at least one discontinuous reception (DRX) configuration, based on the analysis.

Certain aspects provide a method for wireless communication by a base station. The method generally includes determining a discontinuous reception (DRX) configuration for a first user equipment (UE) based on an analysis of statistics related to traffic for one or more UEs and signaling the first UE to enter a DRX mode based on the determined configuration.

Certain aspects provide a method for wireless communication by a base station. The method generally includes receiving downlink data for a user equipment that is in a low power state of a discontinuous reception (DRX) mode of operation, buffering the downlink data until the UE is scheduled to awaken from the DRX mode, and transmitting the buffered downlink data to the UE.

Certain aspects provide a method for wireless communication by a user equipment (UE). The method generally includes receiving uplink data for a base station, while the UE is in a low power state of a discontinuous reception (DRX) mode of operation, buffering the uplink data until the UE is scheduled to awaken from the DRX mode, and transmitting the buffered uplink data to the UE.

Certain aspects provide an apparatus comprising for wireless communications. The apparatus generally includes means for analyzing statistics related to packet traffic at a user equipment (UE) and means for providing at least one recommendation to a base station for at least one discontinuous reception (DRX) configuration, based on the analyzing; and a memory coupled with the at least one processor.

Certain aspects provide an apparatus comprising for wireless communications. The apparatus generally includes means for determining a discontinuous reception (DRX) configuration for a first user equipment (UE) based on an analysis of statistics related to traffic for one or more UEs and means for signaling the first UE to enter a DRX mode based on the configuration; and a memory coupled with the at least one processor.

Certain aspects provide an apparatus comprising for wireless communications. The apparatus generally includes means for receiving downlink data for a user equipment (UE) that is in a low power state of a discontinuous reception (DRX) mode, means for buffering the downlink data until the UE is scheduled to awaken from the DRX mode, and means for transmitting the downlink data to the UE; and a memory coupled with the at least one processor.

Certain aspects provide an apparatus comprising for wireless communications. The apparatus generally includes means for receiving uplink data for a base station, while a user equipment (UE) is in a low power state of a discontinuous reception (DRX) mode of operation, means for buffering the uplink data until the UE is scheduled to awaken from the DRX mode, and means for transmitting the uplink data to the base station; and a memory coupled with the at least one processor.

Certain aspects provide an apparatus comprising for wireless communications. The apparatus generally includes at least one processor configured to analyze statistics related to packet traffic at a user equipment (UE) and provide at least one recommendation to a base station for at least one discontinuous reception (DRX) configuration, based on the analyzing; and a memory coupled with the at least one processor.

Certain aspects provide an apparatus comprising for wireless communications. The apparatus generally includes at least one processor configured to determine a discontinuous reception (DRX) configuration for a first user equipment (UE) based on an analysis of statistics related to traffic for one or more UEs and signal the first UE to enter a DRX mode based on the configuration; and a memory coupled with the at least one processor.

Certain aspects provide an apparatus comprising for wireless communications. The apparatus generally includes at least one processor configured to receive downlink data for a user equipment (UE) that is in a low power state of a discontinuous reception (DRX) mode, buffer the downlink data until the UE is scheduled to awaken from the DRX mode, and transmit the downlink data to the UE; and a memory coupled with the at least one processor.

Certain aspects provide an apparatus comprising for wireless communications. The apparatus generally includes at least one processor configured to receive uplink data for a base station, while a user equipment (UE) is in a low power state of a discontinuous reception (DRX) mode of operation, buffer the uplink data until the UE is scheduled to awaken from the DRX mode, and transmit the uplink data to the base station; and a memory coupled with the at least one processor.

Certain aspects provide a program product comprising a computer-readable medium having instructions stored thereon. The instructions are generally executable by one or more processors for analyzing statistics related to packet traffic at a user equipment (UE) and providing at least one recommendation to a base station for at least one discontinuous reception (DRX) configuration, based on the analyzing.

Certain aspects provide a program product comprising a computer-readable medium having instructions stored thereon. The instructions are generally executable by one or more processors for determining a discontinuous reception (DRX) configuration for a first user equipment (UE) based on an analysis of statistics related to traffic for one or more UEs and signaling the first UE to enter a DRX mode based on the configuration.

Certain aspects provide a program product comprising a computer-readable medium having instructions stored thereon. The instructions are generally executable by one or more processors for receiving downlink data for a user equipment (UE) that is in a low power state of a discontinuous reception (DRX) mode, buffering the downlink data until the UE is scheduled to awaken from the DRX mode, and transmitting the downlink data to the UE.

Certain aspects provide a program product comprising a computer-readable medium having instructions stored thereon. The instructions are generally executable by one or more processors for receiving uplink data for a base station, while a user equipment (UE) is in a low power state of a discontinuous reception (DRX) mode of operation, buffering the uplink data until the UE is scheduled to awaken from the DRX mode, and transmitting the uplink data to the base station.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates an example wireless communication system according to an aspect of the present disclosure.

FIG. 2 is a block diagram conceptually illustrating an example of a Node B in communication with a user equipment (UE) in a wireless communication system, according to an aspect of the present disclosure.

FIG. 3 illustrates an example of discontinuous reception (DRX) optimization by a UE, according to an aspect of the present disclosure.

FIG. 4 illustrates an example of discontinuous reception (DRX) optimization by an eNB, according to an aspect of the present disclosure.

FIG. 5 is a flow diagram of example operations, which may be performed by a UE, for optimizing DRX, according to an aspect of the present disclosure.

FIG. 6 is a flow diagram of example operations, which may be performed by a base station (e.g., an eNB), for optimizing DRX, according to an aspect of the present disclosure.

FIG. 7 is a flow diagram of example operations, which may be performed by a base station (e.g., an eNB), for optimizing DRX, according to an aspect of the present disclosure.

FIG. 8 is a flow diagram of example operations, which may be performed by a UE, for optimizing DRX, according to an aspect of the present disclosure.

FIG. 9 illustrates example components capable of performing the operations illustrated in FIGS. 5 and 8.

FIG. 10 illustrates example components capable of performing the operations illustrated in FIGS. 6 and 7.

### DESCRIPTION

Aspects of the present disclosure may be used to optimize discontinuous reception (DRX) operations. By carefully selecting parameters for a DRX configuration based on an analysis of traffic, power consumption may be reduced while still maintaining performance. As will be described in greater detail below, various aspects may involve operations performed at a UE, while others may involve operations performed at a base station.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11 (WiFi), IEEE 802.16 (WiMAX), IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA) is a transmission technique that utilizes single carrier modulation at a transmitter side and frequency domain equalization at a receiver side. SC-FDMA has similar performance and essentially the same overall complexity as those of OFDMA. However, an SC-FDMA signal has lower peak-to-average power ratio (PAPR) because of its inherent single carrier structure. SC-FDMA has drawn great attention, especially in uplink communications where lower PAPR greatly benefits the mobile terminal in terms of transmit power efficiency. It is currently a working assumption for uplink multiple access scheme in 3GPP LTE, LTE-A, and E-UTRA.

### An Example Wireless Communication System

Referring to FIG. 1, a multiple access wireless communication system according to one aspect is illustrated. An access point 100 (AP) includes multiple antenna groups, one including antenna 104 and antenna 106, another including antenna 108 and antenna 110, and yet another including antenna 112 and antenna 114. In FIG. 1, only two antennas are shown for each antenna group; however, more or fewer antennas may be utilized for each antenna group. Access terminal 116 (AT) is in communication with antennas 112 and 114, where antennas 112 and 114 transmit information to access terminal 116 over forward link 120 (also known as a downlink) and receive information from access terminal 116 over reverse link 118 (also known as an uplink). Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124, and 126 may use different frequencies for communication. For example, forward link 120 may use a different frequency then that used by reverse link 118.

Each group of antennas and/or the area in which they are designed to communicate is often referred to as a sector of the access point. In an aspect, antenna groups each are designed to communicate to access terminals in a sector, of the areas covered by the access point 100.

In communication over forward links 120 and 126, the transmitting antennas of the access point 100 utilize beamforming in order to increase the signal-to-noise ratio (SNR) of forward links for the different access terminals 116 and 122. Also, an access point using beamforming to transmit to access terminals scattered randomly through the access point's coverage area causes less interference to access terminals in neighboring cells than an access point transmitting through a single antenna to all the access point's access terminals.

An access point (AP) may be a fixed station used for communicating with the terminals and may also be referred to as a base station (BS), a Node B, an evolved Node B (eNB), or some other terminology. An access terminal may also be called a mobile station (MS), user equipment (UE), a wireless communication device, terminal, user terminal (UT), or some other terminology.

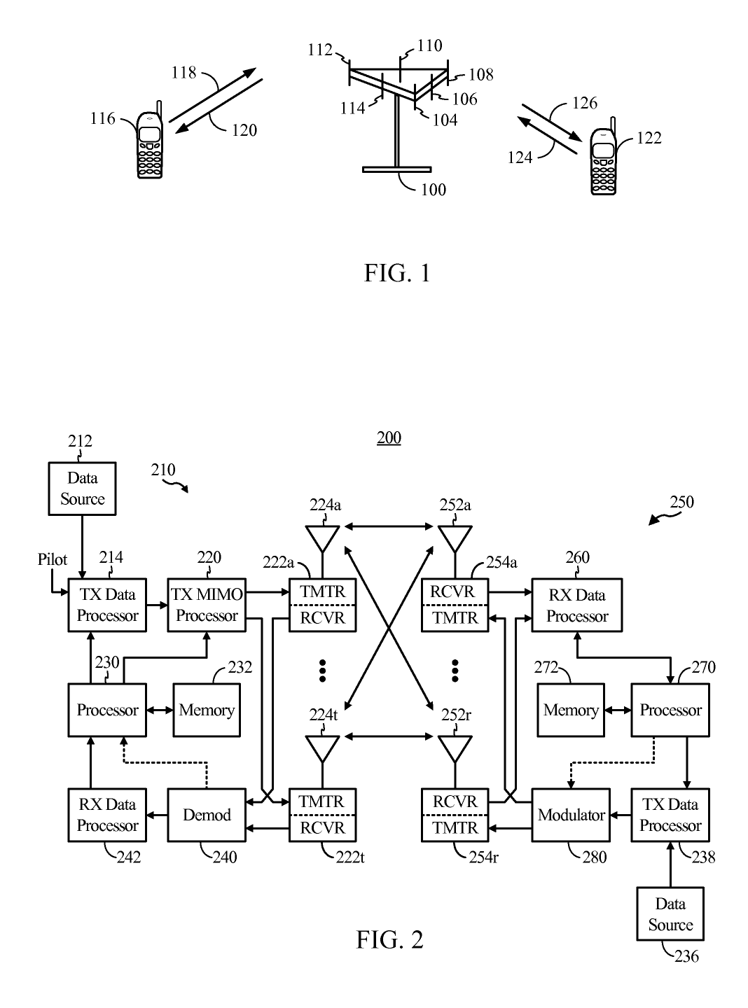

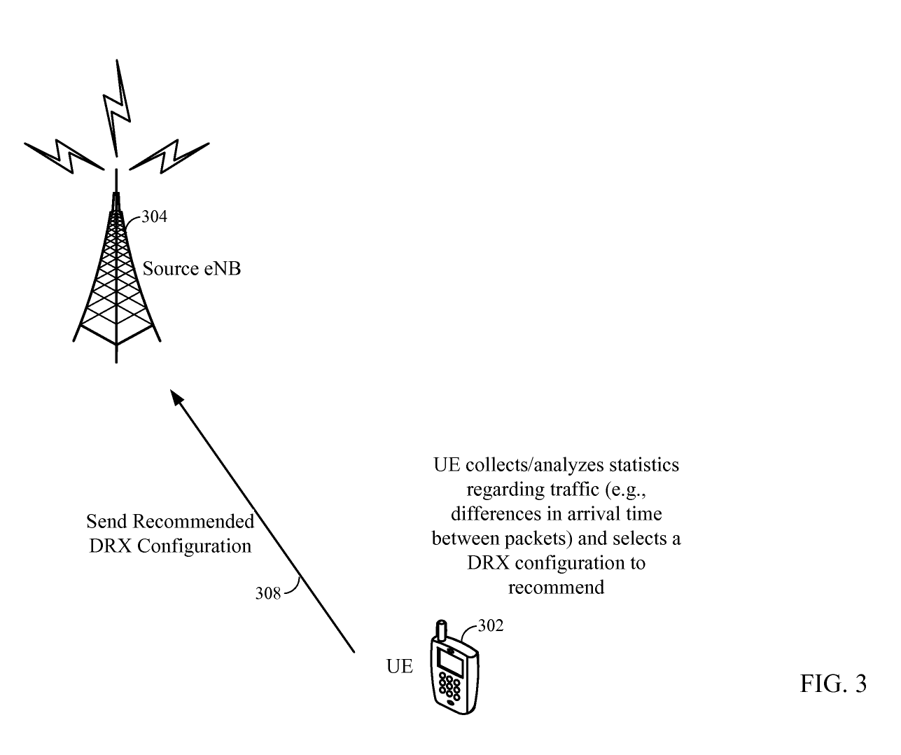

FIG. 2 is a block diagram of an aspect of a transmitter system 210 (also known as an access point) and a receiver system 250 (also known as an access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reverse link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprise Broadcast Control Channel (BCCH) which is a downlink (DL) channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing a Radio Resource Control (RRC) connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and uplink (UL). DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to physical layer (PHY) resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

The DL PHY channels comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprise:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RB Resource Block

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

### Example DRX Mode Operations

With the ever-increasing popularity of smart phones, there are many new challenges for the design of wireless systems, including power consumption and signaling demands. For example, instead of being awake only for the typically small percentage of talk time, smart phones are awake much more often. Applications, such as e-mail or social networking, may send “keep-alive” message every 20 to 30 minutes, for example. Such applications often use many small and bursty data transmissions that may entail a significantly larger amount of control signaling. Some system level evaluations have identified control channel limitations in addition to traffic channel limitations.

Discontinuous Reception (DRX) is a method used in mobile communication to reduce power consumption, thereby conserving the battery of the mobile device. The mobile device and the network negotiate phases in which data transfer occurs, where the mobile device's receiver is turned on. During other times, the mobile device turns its receiver off and enters a low power state. There is usually a function designed into the protocol for this purpose. For example, the transmission may be structured in slots with headers containing address details so that devices may listen to these headers in each slot to decide whether the transmission is relevant to the devices or not. In this case, the receiver may only be active at the beginning of each slot to receive the header, conserving battery life. Other DRX techniques include polling, whereby the device is placed into standby for a given amount of time and then a beacon is sent by the base station periodically to indicate if there is any data waiting for it.

In LTE, DRX is conventionally controlled by the RRC protocol. RRC signaling typically sets a cycle where the UE's receiver is operational for a certain period of time, typically coinciding with when all the scheduling and paging information is transmitted. The serving evolved Node B (eNB) knows that the UE's receiver is completely turned off and is not able to receive anything. Except when in DRX, the UE's receiver may most likely be active to monitor the Physical Downlink Control CHannel (PDCCH) to identify downlink data. During DRX, the UE's receiver may be turned off In LTE, DRX may also apply to the RRC_Idle state with a longer cycle time than active mode.

There are two RRC states for a UE: (1) RRC_Idle where the radio is not active, but an identifier (ID) is assigned to the UE and tracked by the network; and (2) RRC_Connected with active radio operation having context in the eNB.

In active mode, there is a dynamic transition between long DRX and short DRX. Long DRX has a longer “off” duration. Durations for long and short DRX are configured by the RRC protocol. The transition is determined by the eNB (e.g., with MAC commands) or by the UE based on an inactivity timer. For example, a lower duty cycle may be used during a pause in speaking during a voice over Internet protocol (VoIP) call; packets are arriving at a lower rate, so the UE can remain off for a longer period of time. When speaking resumes, this results in lower latency. As packets are arriving more often, the DRX interval may be reduced during this period.

Current DRX techniques may be less than optimal for the wide variety of applications supported by smart phones. However, aspects of the present disclosure may allow a UE and/or base station to determine DRX configurations in a manner that may help accommodate applications that involve relatively steady traffic for a short period of time (e.g., voice calls), as well as social media applications that require bursty traffic, such as e-mail and social media applications. Thus, the techniques used herein may help optimize DRX operations for these applications have different signaling demands For example, small bursty data typically requires significantly larger amount of control signaling. Because DRX configurations have a large range, it is hard to optimize DRX configurations for all types of applications.

With traditional voice calls, people are either on the phone talking or inactive. However, many current smart phones have completely different usage patterns. Some applications that run on the smart phone, such as video streaming or video conferencing, can generate large amount of traffic. Other applications, such as email applications, generate periodic updates even during nighttime. Thus, actual talk time may only constitute a small fraction of phone usage. Selecting an appropriate DRX configuration for such applications becomes important for power and control signal reduction. In addition, due to the different user and application behavior, it is unlikely a fixed configuration will work universally for all users.

Certain aspects of the present disclosure, however, allow for what may be considered “UE-assisted” DRX operation. In this case, a UE may perform various operations to assist DRX operation optimization.

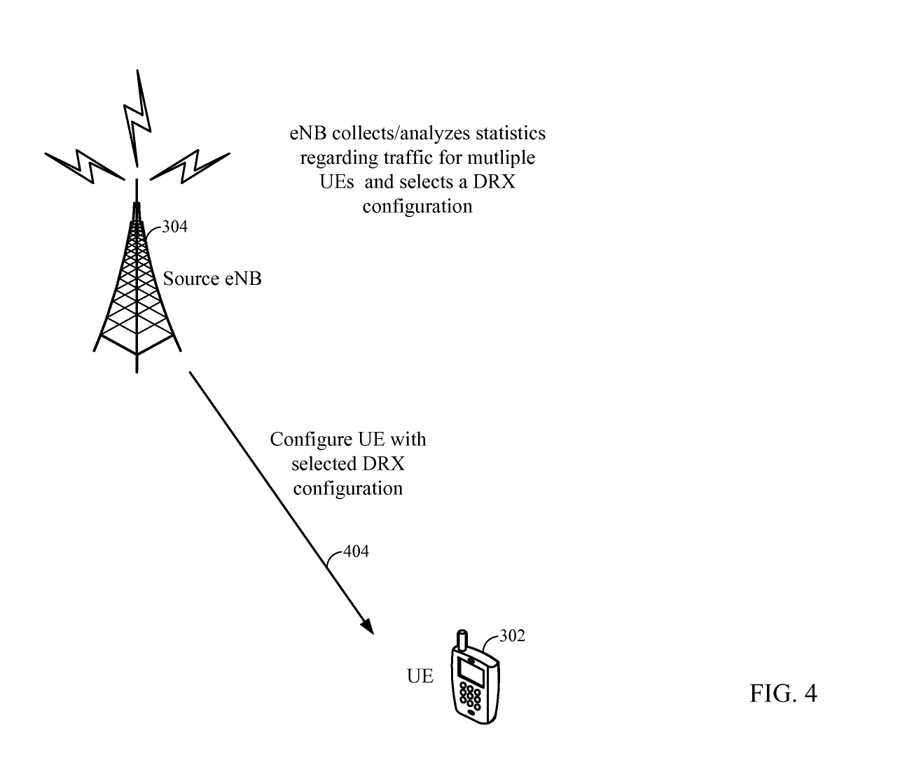

An example of UE-assisted DRX operation is illustrated in FIG. 3. As illustrated, a UE 302 may collect and analyze various statistics regarding traffic and select a DRX configuration (e.g., a combination of DRX parameters, such as DRX cycle and inactivity time) to recommend to a base station based on the analyzed statistics. The UE 302 may then send the recommended DRX configuration to a base station (e.g., eNB 304), as shown at 310.

According to certain aspects, the UE may track a parameter, such as packet arrival statistics, for example, based on a Cumulative Distribution Function (CDF) of inter-arrival time between packets. A UE may collect these statistics over an extended period of time, which may not be possible at the eNB side. Based on these statistics, provide recommended values, such as an inactivity timer and DRX cycle selected to match the monitored statistics.

These recommended values may be transmitted from the UE to the eNB, for example, upon RRC connection setup. As necessary, the UE may also provide updates to the network if there are significant changes to the configuration (e.g., based on continued monitoring of traffic statistics).

The eNB may signal to the UE to confirm the DRX configuration. Even in the UE-assisted scenario, however, the eNB may still have the option to modify the parameters, for example, based on its loading or other considerations.

According to other aspects of DRX optimization, an “eNB DRX adaptation” approach may be used, for example, where an eNB adapts to change DRX parameters even without UE feedback (e.g., where there no UE feedback is available).

An example of eNB DRX adaptation is illustrated in FIG. 4. As illustrated, an eNB 304 may collect and analyze various statistics regarding traffic, for a group of UEs served by the eNB, and select a DRX configuration based on the analyzed statistics. The eNB 304 may then configure UE 302 with the selected DRX configuration, as shown at 404.

Due to the significant number of UEs that may be connected to the same eNB, it may be a challenge for an eNB to optimize DRX parameters for each individual UE. Thus, according to certain aspects, an eNB may collect statistics across all users and identify a common (or default) DRX configuration to use for all users initially, assuming that all users have similar usage pattern (e.g., assuming users use similar applications, such as email, web browsing, etc.).

To adapt to changing traffic patterns, the eNB may update the statistics regularly and adapt the DRX settings, providing updated configurations, accordingly. According to certain aspects, an eNB may utilize an adaptive algorithm with self correction by apply default DRX configurations to all UEs and then adapt the DRX configuration based on a second set of the users packet statistics.

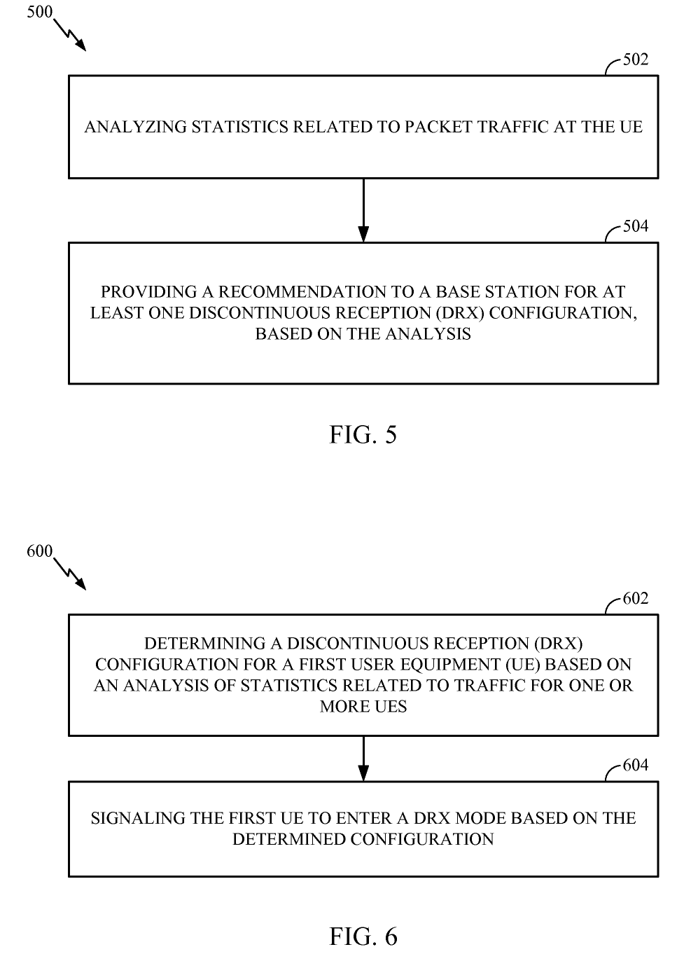

FIG. 5 is a flow diagram of example operations 500 for optimizing DRX, which may be performed by an apparatus, such as the UE 302 shown in FIG. 3. The operations may begin, at 502, by analyzing statistics related to packet traffic at the UE. At 504, the UE provides a recommendation to a base station for at least one discontinuous reception (DRX) configuration, based on the analysis.

FIG. 6 is a flow diagram of example operations 600 for optimizing DRX, which may be performed by an apparatus, such as the eNB 304 shown in FIG. 4. The operations may begin, at 602, by determining a discontinuous reception (DRX) configuration for a first user equipment (UE) based on an analysis of statistics related to traffic for one or more UEs. At 604, the eNB signals the first UE to enter a DRX mode based on the determination.

According to certain aspects, multiple DRX configurations or recommendations may be used to address significantly different behavior for different periods of the day (e.g., daytime vs. nighttime). Additionally, different applications may have significantly different profiles as well. One possible approach is for a UE to provide multiple sets of DRX configurations based on its usage (e.g., parameters such as time of day, location, user profile, application, subscription, traffic, etc.). These configurations may be conveyed to the eNB upon connection setup, and/or dynamically signaled to eNB for selection. For example, the UE can signal to the eNB about its choice of a DRX configuration through in-band signaling, such as in a MAC header.

An alternative (or additional) solution to the UE providing the eNB with multiple DRX configurations is for the eNB to apply different DRX configurations based on its loading or other parameters such as time of day, etc. These configurations may be signaled to the UE when setting up the DRX modes. After the eNB configures UE for multiple DRX configurations, it may dynamically switch the UE among the configurations. For example, the eNB may send a PDCCH command instead of higher layer signaling.

In yet another aspect of DRX optimization, an adaptive DRX approach may be used because even if a fixed DRX configuration is used. This approach may be used at either or both of the UE and the eNB to adapt the transmission in an effort to maximize the DRX saving for power and signaling.

According to one aspect, upon DL arrival, the eNB may accumulate (e.g., in a buffer) traffic before it schedules DL transmission to wake up, or activate, the UE from DRX to service the traffic. Similarly, upon UL arrival, a UE can accumulate traffic before it sends RACH or SR. Such power saving approach may be applied when the UE is in power saving mode.

One possible implementation of this type of optimization is for the UE and/or the eNB to set different level of QOS requirements. For example, data for delay sensitive applications, such as voice, may be sent right away and the UE may transition into active mode as soon as such packet arrives. In contrast, data for delay non-sensitive applications, such as email, may wait until the next “DRX on” duration naturally occurs (according to an existing DRX configuration).

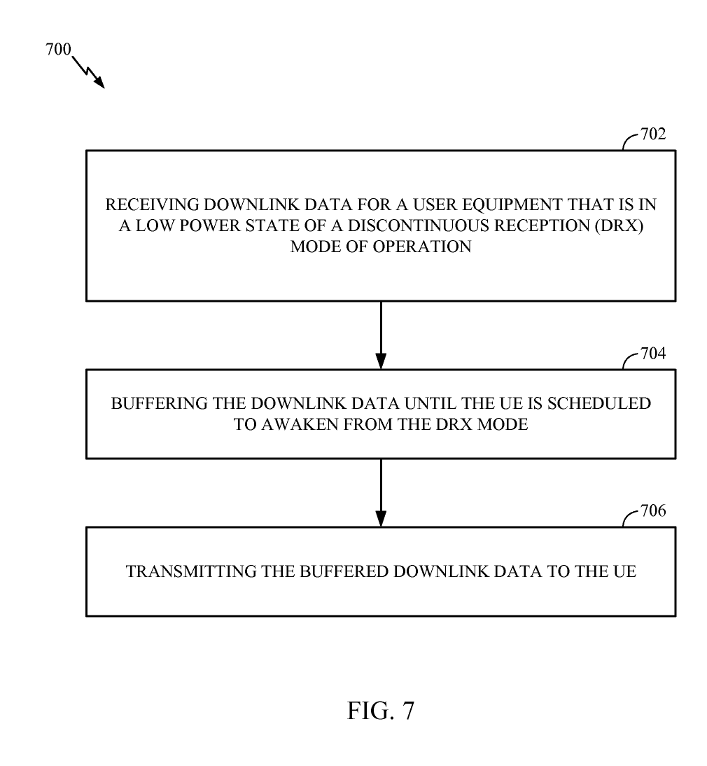

FIG. 7 is a flow diagram of example operations 700 for optimizing DRX by buffering data by an eNB. The operations may begin, at 702, by receiving downlink data for a user equipment (UE) that is in a low power state of a discontinuous reception (DRX) mode of operation. At 704, the eNB buffers the downlink data until the UE is scheduled to awaken from the DRX mode and, at 706, transmits the buffered downlink data to the UE (e.g., after the scheduled wake).

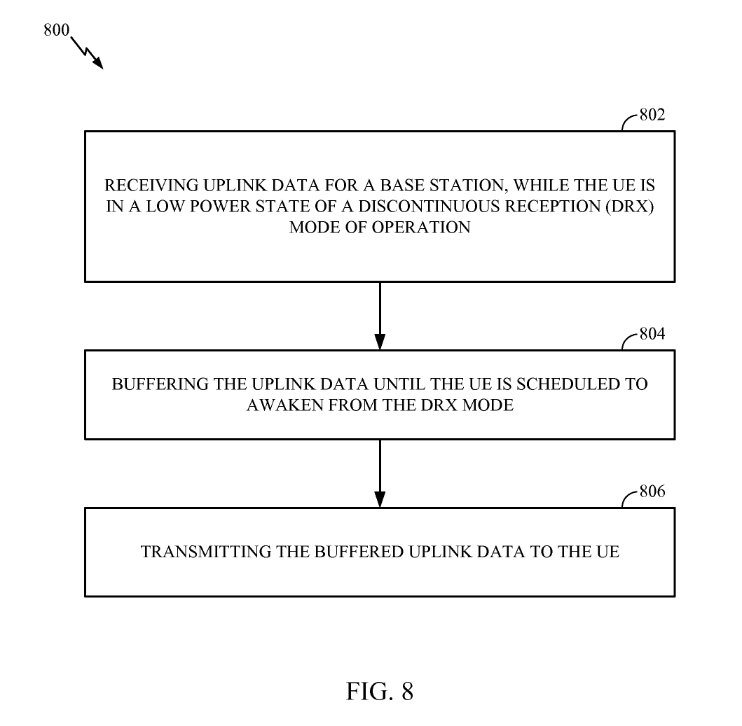

FIG. 8 is a flow diagram of example operations 800 for optimizing DRX by buffering data by a UE. The operations may begin, at 802, by receiving uplink data for a base station, while the UE is in a low power state of a discontinuous reception (DRX) mode of operation. At 804, the UE may buffer the uplink data until the UE is scheduled to awaken from the DRX mode. At 806, the UE may transmit the buffered uplink data to the UE (e.g., after the scheduled wake).

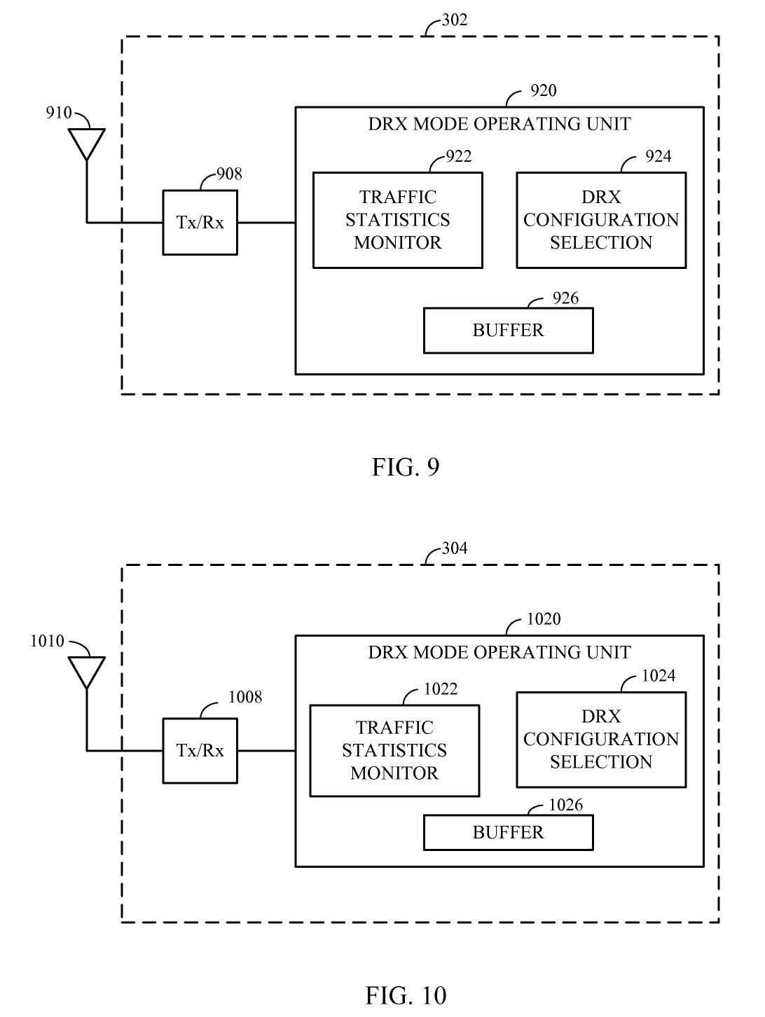

The operations described herein may be performed by any suitable components or other means capable of performing the corresponding functions. For example, operations 500 and 800 illustrated in FIGS. 5 and 8 may be performed by components of a UE 302 shown in FIG. 9. As illustrated, a DRX mode operating unit 920 may include a traffic statistics monitor 922 and a DRX configuration selection component 924. The DRX mode operating unit may also include a buffer 926, for example, to buffer uplink data of a certain QoS until a DRX awaken cycle.

For certain aspects, the DRX mode operating unit 920 may be part of a processing system, such as the processor 270 of the receiver system 250 in FIG. 2. A transceiver 908, which may function similar to the receiver/transmitters 254, may receive signals via an antenna 910, which may function similar to the antennas 252 of FIG. 2.

Similarly, operations 600 and 700 illustrated in FIGS. 6 and 7 may be performed by components of an eNB 304 shown in FIG. 10. As illustrated, a DRX mode operating unit 1020 may include a traffic statistics monitor 1022 and a DRX configuration selection component 1024. The DRX mode operating unit 1020 may also include a buffer 1026, for example, to buffer downlink data of a certain QoS until a DRX awaken cycle.

For certain aspects, the DRX mode operating unit 1020 may be part of a processing system, such as the processor 230 of the transmitter system 210 in FIG. 2. A transceiver 1008, which may function similar to the receiver/transmitters 222, may receive signals via an antenna 1010, which may function similar to the antennas 224 of FIG. 2.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the figures, those operations may have corresponding counterpart means-plus-function components with similar numbering.

More particularly, means for transmitting, mean for sending, or means for forwarding may comprise a transmitter, such as the transmitter 254 illustrated in FIG. 2. Means for receiving may comprise a receiver, such as the receiver 254 illustrated in FIG. 2. Means for determining, means for processing, means for operating, means for detecting, means for performing, or means for transitioning may comprise a processing system having at least one processor, such as the processor 270 illustrated in FIG. 2. Means for storing may comprise a memory, such as the memory 272 of FIG. 2.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method for wireless communication by a user equipment (UE), comprising:
analyzing statistics related to packet traffic at the UE; and
providing at least one recommendation to a base station for at least one discontinuous reception (DRX) configuration, based on the analyzing.

2. The method of claim 1, wherein the statistics comprise:
statistics related to inter-arrival time between packets.

3. The method of claim 1, wherein the at least one recommendation comprises:
a recommended inactivity timer and a DRX cycle.

4. The method of claim 1, wherein the recommendation is provided during a radio resource control (RRC) connection setup.

5. The method of claim 1, further comprising:
providing an updated recommendation to the base station for a DRX configuration based on a change in statistics.

6. The method of claim 1, further comprising:
receiving signaling from the base station to enter a DRX mode with the at least one DRX configuration.

7. The method of claim 1, further comprising:
receiving signaling from the base station to enter a DRX mode with a DRX configuration different than the at least one DRX configuration.

8. The method of claim 1, wherein the at least one recommendation for at least one DRX configuration comprises recommendations for a plurality of DRX configurations.

9. The method of claim 8, wherein the plurality of DRX configurations comprise different DRX configurations for different periods of time.

10. The method of claim 8, wherein the plurality of DRX configurations comprise different DRX configurations for different applications.

11. A method for wireless communications by a base station, comprising:
determining a discontinuous reception (DRX) configuration for a first user equipment (UE) based on an analysis of statistics related to traffic for one or more UEs; and
signaling the first UE to enter a DRX mode based on the configuration.

12. The method of claim 11, wherein the statistics comprise:
statistics related to inter-arrival time between packets.

13. The method of claim 11, wherein the analyzing comprises:
analyzing traffic statistics for a plurality of UEs served by the base station.

14. The method of claim 13, wherein the base station initially configures the plurality of UEs with the same DRX configuration.

15. The method of claim 14, wherein the base station adapts the DRX configuration for at least one of the plurality of UEs based on packet statistics.

16. The method of claim 11, further comprising:
receiving, from the first UE, a recommendation for at least one discontinuous reception (DRX) configuration, based on an analysis of traffic statistics performed at the first UE; and
determining the DRX configuration based, at least in part, on the recommendation.

17. The method of claim 16, wherein the recommendation is provided during a radio resource control (RRC) connection setup.

18. The method of claim 16, wherein:
the first UE is signaled to enter a DRX mode with a different DRX configuration than recommended by the UE.

19. The method of claim 16, wherein:
the recommendation comprises recommendations for a plurality of DRX configurations for different periods of time; and
the determining comprises selecting one of the plurality of DRX configurations appropriate for a current time.

20. The method of claim 16, wherein:
the recommendation comprises recommendations for a plurality of DRX configurations for different applications; and
the determining comprises selecting one of the plurality of DRX configurations appropriate for a current application.

21. A method for wireless communications by a base station, comprising:
receiving downlink data for a user equipment (UE) that is in a low power state of a discontinuous reception (DRX) mode;
buffering the downlink data until the UE is scheduled to awaken from the DRX mode; and
transmitting the downlink data to the UE.

22. The method of claim 21, wherein:
the buffering comprises buffering downlink data of a first quality of service (QoS) level.

23. The method of claim 22, further comprising:
receiving downlink data of a second QoS level; and
transmitting the downlink data of the second QoS level without buffering to awaken the UE from the DRX mode.

24. A method for wireless communications by a user equipment (UE), comprising:
receiving uplink data for a base station, while the UE is in a low power state of a discontinuous reception (DRX) mode of operation;
buffering the uplink data until the UE is scheduled to awaken from the DRX mode; and
transmitting the uplink data to the base station.

25. The method of claim 24, wherein:
the buffering comprises buffering uplink data of a first quality of service (QoS) level.

26. The method of claim 25, further comprising:
receiving uplink data of a second QoS level; and
transmitting the uplink data of the second QoS level without waiting until the UE is scheduled to awaken from the DRX mode

27. An apparatus for wireless communication, comprising:
means for analyzing statistics related to packet traffic at a UE; and
means for providing at least one recommendation to a base station for at least one discontinuous reception (DRX) configuration, based on the analyzing.

28. The apparatus of claim 27, wherein the statistics comprise:
statistics related to inter-arrival time between packets.

29. The apparatus of claim 27, wherein the at least one recommendation comprises:
a recommended inactivity timer and a DRX cycle.

30. The apparatus of claim 27, wherein the recommendation is provided during a radio resource control (RRC) connection setup.

31. The apparatus of claim 27, further comprising:
means for providing an updated recommendation to the base station for a DRX configuration based on a change in statistics.

32. The apparatus of claim 27, further comprising:
means for receiving signaling from the base station to enter a DRX mode with the at least one DRX configuration.

33. The apparatus of claim 27, further comprising:
means for receiving signaling from the base station to enter a DRX mode with a DRX configuration different than the at least one DRX configuration.

34. The apparatus of claim 27, wherein the at least one recommendation for at least one DRX configuration comprises recommendations for a plurality of DRX configurations.

35. The apparatus of claim 34, wherein the plurality of DRX configurations comprise different DRX configurations for different periods of time.

36. The apparatus of claim 34, wherein the plurality of DRX configurations comprise different DRX configurations for different applications.

37. An apparatus for wireless communications by a base station, comprising:
means for determining a discontinuous reception (DRX) configuration for a first user equipment (UE) based on an analysis of statistics related to traffic for one or more UEs; and
means for signaling the first UE to enter a DRX mode based on the configuration.

38. The apparatus of claim 37, wherein the statistics comprise:
statistics related to inter-arrival time between packets.

39. The apparatus of claim 37, wherein the means for analyzing comprises:
means for analyzing traffic statistics for a plurality of UEs served by the base station.

40. The apparatus of claim 39, wherein the base station initially configures the plurality of UEs with the same DRX configuration.

41. The apparatus of claim 40, wherein the base station adapts the DRX configuration for at least one of the plurality of UEs based on packet statistics.

42. The apparatus of claim 37, further comprising:
means for receiving, from the first UE, a recommendation for at least one discontinuous reception (DRX) configuration, based on an analysis of traffic statistics performed at the first UE; and
means for determining the DRX configuration based, at least in part, on the recommendation.

43. The apparatus of claim 42, wherein the recommendation is provided during a radio resource control (RRC) connection setup.

44. The apparatus of claim 42, wherein:
the first UE is signaled to enter a DRX mode with a different DRX configuration than recommended by the UE.

45. The apparatus of claim 42, wherein:
the recommendation comprises recommendations for a plurality of DRX configurations for different periods of time; and
the means for determining comprises selecting one of the plurality of DRX configurations appropriate for a current time.

46. The apparatus of claim 42, wherein:
the recommendation comprises recommendations for a plurality of DRX configurations for different applications; and
the means for determining comprises selecting one of the plurality of DRX configurations appropriate for a current application.

47. An apparatus for wireless communications, comprising:
means for receiving downlink data for a user equipment (UE) that is in a low power state of a discontinuous reception (DRX) mode;
means for buffering the downlink data until the UE is scheduled to awaken from the DRX mode; and
means for transmitting the downlink data to the UE.

48. The apparatus of claim 47, wherein:
the means for buffering comprises means for buffering downlink data of a first quality of service (QoS) level.

49. The apparatus of claim 48, further comprising:
means for receiving downlink data of a second QoS level; and
means for transmitting the downlink data of the second QoS level without buffering to awaken the UE from the DRX mode.

50. An apparatus for wireless communications, comprising:
means for receiving uplink data for a base station, while a user equipment (UE) is in a low power state of a discontinuous reception (DRX) mode of operation;
means for buffering the uplink data until the UE is scheduled to awaken from the DRX mode; and
means for transmitting the uplink data to the UE.

51. The apparatus of claim 50, wherein:
the means for buffering comprises buffering uplink data of a first quality of service (QoS) level.

52. The apparatus of claim 51, further comprising:
means for receiving uplink data of a second QoS level; and
means for transmitting the uplink data of the second QoS level without waiting until the UE is scheduled to awaken from the DRX mode.

53. An apparatus comprising for wireless communications, comprising:
at least one processor configured to analyze statistics related to packet traffic at a user equipment (UE) and provide at least one recommendation to a base station for at least one discontinuous reception (DRX) configuration, based on the analyzing; and
a memory coupled with the at least one processor.

54. An apparatus comprising for wireless communications, comprising:
at least one processor configured to determine a discontinuous reception (DRX) configuration for a first user equipment (UE) based on an analysis of statistics related to traffic for one or more UEs and signal the first UE to enter a DRX mode based on the configuration; and
a memory coupled with the at least one processor.

55. An apparatus comprising for wireless communications, comprising:
at least one processor configured to receive downlink data for a user equipment (UE) that is in a low power state of a discontinuous reception (DRX) mode, buffer the downlink data until the UE is scheduled to awaken from the DRX mode, and transmit the downlink data to the UE; and
a memory coupled with the at least one processor.

56. An apparatus comprising for wireless communications, comprising:
at least one processor configured to receive uplink data for a base station, while a user equipment (UE) is in a low power state of a discontinuous reception (DRX) mode of operation, buffer the uplink data until the UE is scheduled to awaken from the DRX mode, and transmit the uplink data to the base station; and
a memory coupled with the at least one processor.

57. A program product comprising a computer-readable medium having instructions stored thereon, the instructions executable by one or more processors for:
analyzing statistics related to packet traffic at a user equipment (UE); and
providing at least one recommendation to a base station for at least one discontinuous reception (DRX) configuration, based on the analyzing.

58. A program product comprising a computer-readable medium having instructions stored thereon, the instructions executable by one or more processors for:
determining a discontinuous reception (DRX) configuration for a first user equipment (UE) based on an analysis of statistics related to traffic for one or more UEs; and
signaling the first UE to enter a DRX mode based on the configuration.

59. A program product comprising a computer-readable medium having instructions stored thereon, the instructions executable by one or more processors for:
receiving downlink data for a user equipment (UE) that is in a low power state of a discontinuous reception (DRX) mode;
buffering the downlink data until the UE is scheduled to awaken from the DRX mode; and
transmitting the downlink data to the UE.

60. A program product comprising a computer-readable medium having instructions stored thereon, the instructions executable by one or more processors for:
receiving uplink data for a base station, while a user equipment (UE) is in a low power state of a discontinuous reception (DRX) mode of operation;
buffering the uplink data until the UE is scheduled to awaken from the DRX mode; and
transmitting the uplink data to the base station.
